(19) United States
(12) Patent Application Publication
(10) Pub. No.: US 2014/0259694 A1
(43) Pub. Date: Sep. 18, 2014

(54) Metal Ring Cutter With Plastic Coating

(71) Applicant: Eric A. OLDHAM, Kenton, OH (US)

(72) Inventor: Eric A. OLDHAM, Kenton, OH (US)

(21) Appl. No.: 13/845,370

(22) Filed: Mar. 18, 2013

(51) Int. Cl. B26B 27/00

(52) U.S. Cl. CPC B26B 27/007
USPC 30/298

(57) ABSTRACT

A ring cutter having a metal ring constructed to be mounted on the finger of a user. A cutting blade is connected to the metal ring. The inner surface of the metal ring is covered by a plastic coating to reduce friction on and prevent irritation of a user's finger during extended periods of use. The plastic coating may be molded on the metal ring to cover the inner and outer surfaces thereof.

### BACKGROUND OF THE INVENTION

The present invention relates to a metal ring cutter and, more particularly, to a metal ring cutter having a plastic coating to reduce friction on a user's finger.

### DESCRIPTION OF THE BACKGROUND ART

Metal ring cutters are used to cut twine and other objects, and generally comprise a metal ring adapted to fit on the finger of a user and having a cutting blade secured to the metal ring and extending forwardly therefrom. In many cases, the metal ring cutter is worn by the user for extended periods of time during which the metal ring can irritate the user's finger on which it is mounted.

To reduce the irritation of the user's finger, some ring cutters have been produced with a ring made of plastic. While such a construction has reduced the finger irritation, in some cases the plastic ring has not been strong enough to be used for a long period of time without structural failure.

Accordingly, a need exists for a ring cutter construction that is durable and reduces the irritation of a user's finger during long periods of use. This need is met by the new and improved ring cutter of the present invention.

### BRIEF SUMMARY OF THE INVENTION

The new and improved ring cutter of the present invention comprises a metal ring that has a plastic coating on an inner surface thereof to reduce friction on and prevent irritation of a user's finger during long periods of use. The metal ring is durable and thus is not subject to structural failure during long periods of use.

The coating on the ring is formed of a suitable plastic such as vinyl, plastisol (liquid vinyl that dries hard when heated), polyamide or nylon, epoxy resin, phenoxy resin or polypropylene. The plastic coating may be of a selected color or pattern to enhance the appearance of the ring cutter.

The plastic coating may be molded on the ring to cover the inner and outer surfaces thereof.

### BRIEF DESCRIPTION OF THE DRAWINGS

FIG. 1 is a perspective view of one embodiment of the ring cutter of the present invention;

FIG. 2 is a perspective view of another embodiment of the ring cutter; and

FIG. 3 is a side elevational view of the embodiment of the ring cutter shown in FIG. 2.

### DETAILED DESCRIPTION OF THE INVENTION

As shown in FIGS. 1-3, the ring cutter 10 comprises a ring 12 formed of a suitable metal, such as steel or aluminum, adapted to fit on the finger of a user. An upstanding bracket 14 is secured at its inner end to the ring 12 and at its outer end to a cutting blade 16 of any suitable construction.

As shown in FIG. 1, the inner surface of the ring 12 is covered by a plastic coating 18 formed of a suitable plastic such as vinyl, plastisol (liquid vinyl that dries hard when heated), polyamide or nylon, epoxy resin, phenoxy resin or polypropylene.

The plastic coating 18 serves to reduce friction on a user's finger during long periods of use and thus prevents irritation of the user's finger and makes it more comfortable to use the ring cutter 10 for an extended period of use.

The plastic coating 18 may be molded on the ring 12 to cover the inner and outer surfaces thereof, as shown in FIGS. 2 and 3.

Since the ring 12 is formed of metal, it is durable and can be used for long periods of time without structural failure.

From the foregoing description, it will be readily seen that the new and improved ring cutter of the present invention is durable and may be used for long periods of time without irritation of a user's finger on which it is mounted.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A ring cutter comprising:
a metal ring constructed to be mounted on the finger of a user, and
a cutting blade connected to the ring,
the ring having a plastic coating on an inner surface thereof to reduce irritation of a user's finger during long periods of use.

2. The ring cutter of claim 1 wherein the plastic coating is formed of vinyl.

3. The ring cutter of claim 1 wherein the plastic coating is formed of plastisol polyamide, epoxy resin, phenoxy resin or polypropylene.

4. The ring cutter of claim 1 wherein the plastic coating covers an outer surface of the ring and is molded thereon.

5. The ring cutter of claim 4 wherein the plastic coating is formed of vinyl.

6. The ring cutter of claim 4 wherein the plastic coating is formed of plastisol polyamide, epoxy resin, phenoxy resin or polypropylene.
